(19) United States
(12) Patent Application Publication
(10) Pub. No.: US 2010/0264172 A1
(43) Pub. Date: Oct. 21, 2010

(54) APPARATUS FOR DISPENSING A LIQUID, SUCH AS VISCOUS, SUBSTANCE

(76) Inventors: Frederik Daniël Nossbaum, Voorburg (NL); Marijn Jan Van Der Wiel, The Hague (NL); Ronald Christiaan Weber, Oisterwijk (NL); Marcel Anthonius Maria Van Schie, Leiden (NL)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/763,878

(22) Filed: Apr. 20, 2010

(30) Foreign Application Priority Data
Apr. 20, 2009 (EP) 09158257.7

(51) Int. Cl. G01F 11/10; G01F 11/00

(52) U.S. Cl. 222/390; 222/386

(57) ABSTRACT

An apparatus for dispensing a liquid substance, for example a viscous substance such as tooth paste or soap, comprises a storage chamber for the substance in communication with a substance outlet, an expulsion member for forcing the substance from the storage chamber towards the substance outlet and a drive mechanism for driving the expulsion member. The expulsion member comprises a plunger provided with a first thread, wherein the drive mechanism comprises a drive nut with corresponding second thread for engaging the first thread, wherein the drive nut is rotatable with respect to the plunger, for instance through a longitudinal movement of the storage chamber in parallel to the plunger.

### BACKGROUND

The discussion below is merely provided for general background information and is not intended to be used as an aid in determining the scope of the claimed subject matter.

Aspects of the invention relate to an apparatus for dispensing a liquid substance, preferably a viscous substance such as tooth paste or soap, comprising a storage chamber for the substance in communication with a substance outlet, an expulsion member for forcing the substance from the storage chamber towards the substance outlet and a drive mechanism for driving the expulsion member.

A known apparatus of this type uses a vacuum based pump mechanism for expelling the substance. Generally, however, such a pump mechanism does not allow to meter the substance accurately.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the present invention the apparatus is an expulsion member comprising a plunger provided with a first thread, wherein the drive mechanism comprises a drive nut with corresponding second thread for engaging the first thread, and wherein the drive nut is rotatable with respect to the plunger.

The engagement between the first and second threads will lead to an accurate movement of the expulsion member with resulting metering and dispensing of an accurate amount of substance, even when this substance is viscous and, in a state of the art apparatus, would require a substantial operating force to be generated (such a substantial operating force generally making it difficult to cause a well-defined movement of the plunger).

The drive nut can be rotatable with respect to the plunger through a longitudinal movement of the storage chamber in parallel to the plunger. When the longitudinal movement of the storage chamber is caused (mostly manually), the engagement between the first and second threads will lead to an accurate movement of the expulsion member with resulting metering and dispensing of an accurate amount of substance.

In an embodiment of the apparatus, a guide housing is provided for longitudinally guiding the plunger while preventing a rotation thereof, wherein the storage chamber is movable longitudinally with respect to the guide housing and wherein the drive mechanism further comprises a converter nut moving longitudinally to and fro in correspondence with the storage chamber while rotating to and fro relative to the guide housing, said converter nut engaging the drive nut for driving it into rotation only when rotating in a first direction.

The converter nut converts the longitudinal movement of the storage chamber into a rotating movement of the drive nut. Whereas the converter nut rotates to and fro in both directions, the drive nut only rotates in a direction which will lead to the desired movement of the plunger. The plunger only can move longitudinally and is prevented from rotation through the guide housing. One manner to do so is to provide the plunger with a non-circular cross-section cooperating with a corresponding part of the guide housing. The guide housing further is used to enable and guide the longitudinal movement of the storage chamber.

It is possible, then, that the guide housing and converter nut together define a guide way and guide pin assembly for causing the to and fro rotation of the converter nut with respect to the guide housing when it moves to and fro longitudinally with respect to said guide housing.

In such a manner the required to and fro rotation of the converter nut which drives the drive nut, can be achieved in an effective manner.

For example the guide housing may comprise at least one stationary guide pin cooperating with a corresponding inclined guide way of the converter nut. It is conceivable too, however, that the converter nut comprises said at least one stationary guide, whereas the corresponding guide way is part of the guide housing.

In one embodiment, the converter nut engages the drive nut by means of a first ratchet and pawl mechanism. Such a mechanism allows the to and fro movement of the converter nut while the drive nut only is driven in one direction.

For assuring that the drive nut only rotates in said one direction, appropriate measures should be taken. For example, in one embodiment of the apparatus, the drive nut cooperates with a second ratchet and pawl mechanism which prevents a rotation of the drive nut opposite to the rotation caused by the converter nut.

The accuracy with which the apparatus may dispense the substance may be increased substantially when, in accordance with yet another embodiment, the number of ratchets differs from the number of pawls. When, for example, the number of ratchets and pawls both equals 20, the required minimal operating rotation equals 360°/20=18°. When, however, in such a case the number of pawls equals 21, the required minimal operating rotation equals 18°/21=0.86° (after a rotation of 18° all 21 pawls successively have engaged a corresponding ratchet).

When, in accordance with an embodiment of the apparatus, the storage chamber is detachable from the guide housing, the storage chamber may be replaced by a new storage chamber when empty or when one wishes to dispense a different substance. An empty storage chamber may be discarded or may be refilled.

In case the storage chamber is detachable from the guide housing, it may be preferable that the drive nut is deformable between an expanded state in which its second thread does not engage the first thread of the plunger and a compressed state in which said threads are in engagement and wherein the storage chamber, when attached to the guide housing, engages the drive nut for keeping it in the compressed state.

In its compressed state (i.e. when the storage chamber is attached to the guide housing) the drive nut is capable of moving the plunger. When the storage chamber is detached from the guide housing, for example when it is empty, the drive nut expands and disengages the plunger which then may return to its original starting position (whether by gravity or by other means such as a spring). As such a new storage chamber may be attached to the guide housing which again compresses the drive nut for engaging the plunger. Thus, the use of such a special drive nut eliminates the necessity to move the plunger back to its original position by rotating the drive nut.

When such a deformable drive nut is provided, it may be preferable that the sides of the cooperating first and second threads engaging each other when the drive nut moves the plunger for dispensing the liquid substance, extend substantially perpendicularly to the direction of movement of the plunger. As a result no radial outwardly oriented forces are generated on the drive nut which would tend to move it to the expanded state.

Constructively and operationally it may be advantageous when the guide housing comprises a stationary lower part and a movable upper collar which can move to and fro longitudinally with respect to the stationary lower part, wherein the storage chamber engages said collar for moving in unison wherewith and wherein the collar engages the converter nut for causing the longitudinal movement thereof.

In one embodiment of the apparatus, a compression spring is provided for loading the storage chamber relative to the guide housing. The compression spring automatically moves back the storage chamber to its starting position relative to the guide housing, such that operation of the apparatus may be carried out single-handed.

It is possible too that a compression spring is positioned between the plunger and the guide housing. Such a compression spring may serve two goals. Firstly it will dampen the movement of the plunger when the latter returns to its starting position (when the storage chamber has been removed and the drive nut has expanded). Secondly it will allow a slight settling movement of the plunger when the drive nut is compressed and the first and second threads are getting engaged.

Finally it is possible that means are provided for setting the allowed longitudinal movement of the storage chamber. Such means would allow setting the amount of substance dispensed during a full stroke of the storage chamber.

### BRIEF DESCRIPTION OF THE DRAWINGS

Hereinafter aspects of the invention will be elucidated while referring to the drawing in which an embodiment of the apparatus is illustrated.

FIG. 1 shows in perspective and in cross section an embodiment of the apparatus in a nearly emptied state;

FIG. 2 shows a perspective view of part of the guide housing, plunger and drive nut in an assembled state;

FIG. 3 shows another perspective view of part of the guide housing, plunger and drive nut in an assembled state;

FIG. 4 shows a longitudinal cross section of FIG. 2;

FIG. 5 shows parts of the apparatus in a disassembled state;

FIG. 6 shows the guide housing with compression spring in a disassembled state;

FIG. 7 essentially shows parts of the drive mechanism in a disassembled state;

FIG. 8 shows the storage chamber, piston and plunger in a disassembled state; and

FIG. 9 shows in perspective an assembled apparatus.

### DETAILED DESCRIPTION OF THE ILLUSTRATIVE EMBODIMENTS

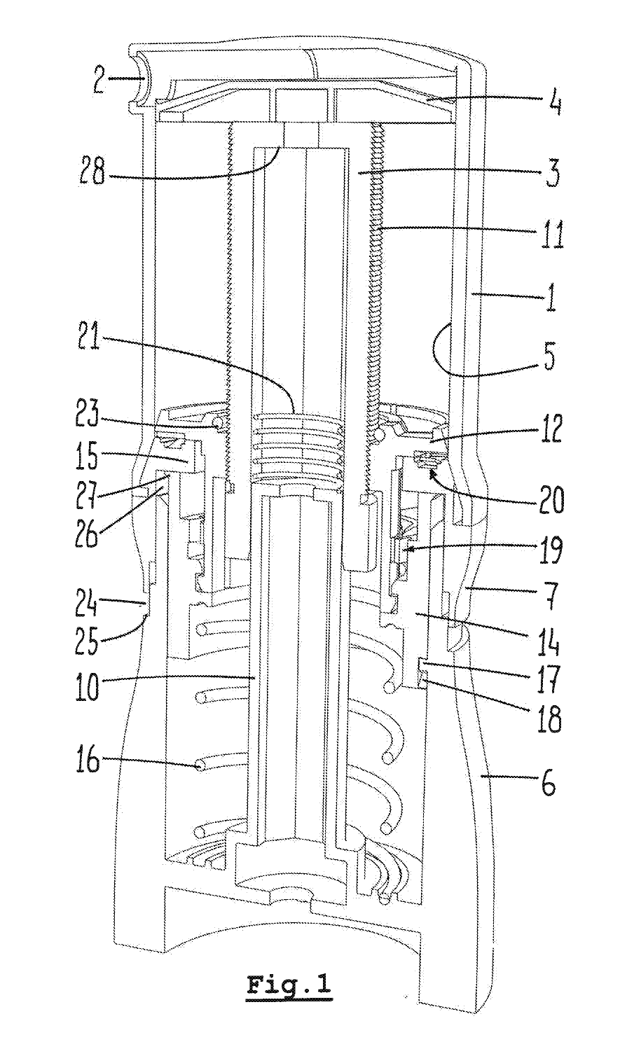

Firstly referring to FIG. 1, the apparatus for in a controlled and precisely metered manner dispensing a liquid substance, preferably but not limited to a viscous substance such as tooth paste or soap, comprises a storage chamber 1 for the substance. This storage chamber 1 communicates with a substance outlet 2 which, in a manner not shown in detail, may be closed by closure means such as a check valve, which open automatically when the substance is expelled from the storage chamber 1.

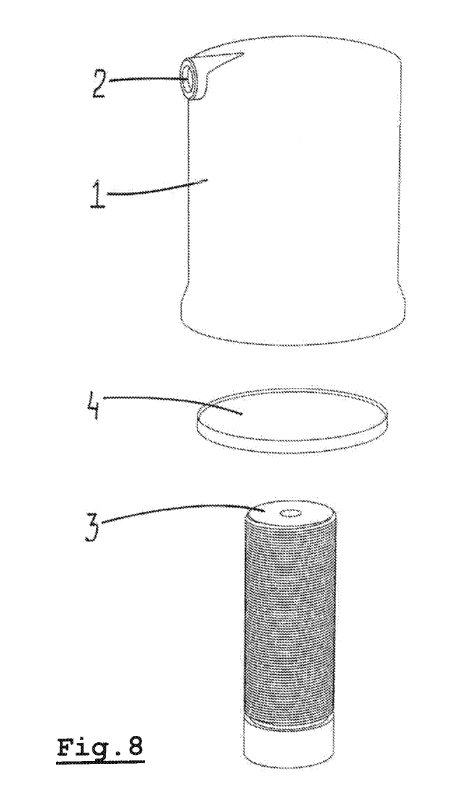

An expulsion member for forcing the substance from the storage chamber 1 towards the substance outlet 2 comprises a plunger 3 for driving a piston 4. The piston 4, which does not form an integral part of the plunger 3 but instead is part of the storage chamber (as suggested by FIG. 8), engages the inner circumferential wall 5 of the storage chamber 1 in a sealing manner. Appropriate sealing member(s) such as but not limited to an o-ring for achieving this are well known.

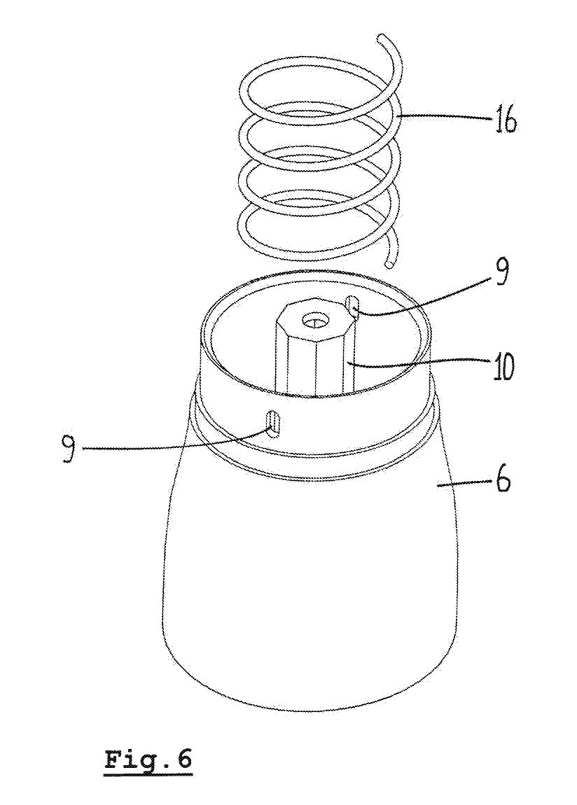

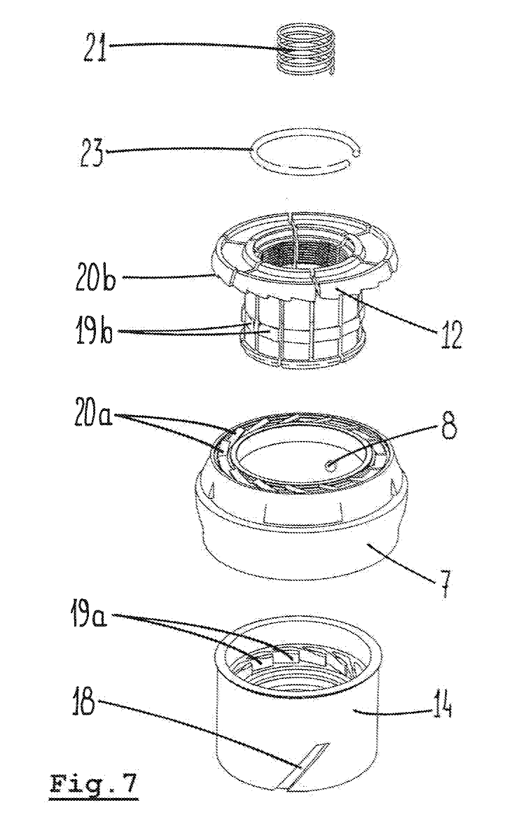

A guide housing is provided which comprises a stationary lower part 6 and a movable upper collar 7 which can move to and fro longitudinally with respect to the stationary lower part 6. For example, the collar 7 may comprise pins 8 cooperating with longitudinal grooves 9 in the lower guide housing part 6 (see FIGS. 6 and 7). The storage chamber 1 engages said collar 7 for moving in unison therewith and thus is movable longitudinally with respect to the stationary lower part 6 of the guide housing. In one embodiment, the storage chamber 1 is detachable from the collar 7, for example using a bayonet coupling or other similar means (not illustrated).

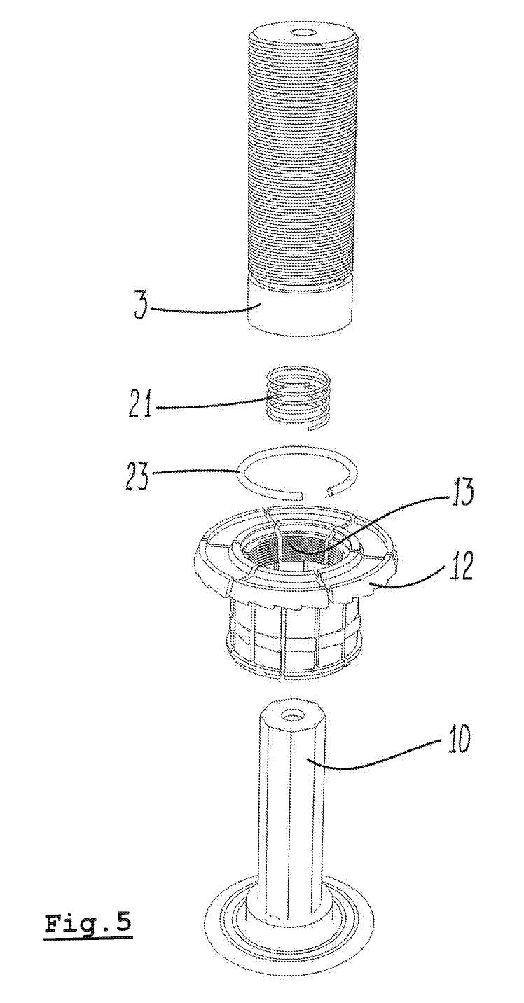

Said guide housing further comprises a stationary central column 10 for longitudinally guiding the plunger 3 while preventing a rotation thereof. Referring to FIG. 5 the central column 10, in the illustrated embodiment, is provided with an octagonal outer contour and the plunger 3 in a corresponding manner has an octagonal inner contour, which impedes a rotation of the plunger 3 with respect to the guide housing.

A drive mechanism is provided for driving the expulsion member (plunger 3 with piston 4) towards the end of the storage chamber 1 where the substance outlet 2 is located. As a part of this drive mechanism the plunger 3 firstly comprises an outer thread 11. The drive mechanism secondly comprises a drive nut 12 with corresponding inner thread 13 (best seen in FIG. 5) for engaging the outer thread 11 of the plunger 3. In a manner to be explained below the drive nut 12 is rotatable with respect to the plunger 3 through a longitudinal movement of the storage chamber 1 in parallel to the plunger 3 and relative to the stationary lower part 6 of the guide housing.

The drive mechanism further comprises a converter nut 14 moving longitudinally to and fro in correspondence with the storage chamber 1 while rotating to and fro relative to the stationary lower part 6 of the guide housing. For achieving its movement in correspondence with the storage chamber 1 the converter nut 14 at its upper end engages an inwardly projecting shoulder 15 of the collar 7. This engagement is maintained by a compression spring 16 positioned between the stationary lower part 6 of the guide housing and the converter nut 14.

The lower part 6 of the guide housing and the converter nut 14 together define a guide way and guide pin assembly for causing the to and fro rotation of the converter nut 14 with respect to the lower part 6 of the guide housing when the converter nut 14 moves to and fro longitudinally. Specifically, in the illustrated embodiment, the stationary lower part 6 of the guide housing comprises at least one stationary guide pin 17 cooperating with an inclined guide way 18 (best seen in FIG. 7) of the converter nut 14.

Said converter nut 14 engages the drive nut 12 in such a manner that the latter is driven into rotation only when the converter nut 14 rotates in a first direction, as caused by a downward movement of the converter nut 14 relative to the stationary lower part 6 of the guide housing.

For achieving such a selective rotation of the drive nut 12 the converter nut 14 engages the drive nut 12 by means of a first ratchet and pawl mechanism 19, the components of which are indicated, for example, in FIG. 7 as parts 19a and 19b.

Moreover the drive nut 12 engages the collar 7 by means of a second ratchet and pawl mechanism 20 which prevents a rotation of the drive nut 12 opposite to the rotation caused by the converter nut 14. The components of said second ratchet and pawl mechanism 20 are indicated, for example, in FIG. 7 as parts 20a and 20b.

The number of ratchets and the number of pawls in a ratchet and pawl mechanism 19,20 may differ for dramatically reducing the minimal required operating rotation, as has been explained above.

Finally FIG. 1 shows a compression spring 21 positioned within the plunger 3 and resting on top of the central column 10 of the stationary lower part 6 of the guide housing. The function of this compression spring 21 will appear below.

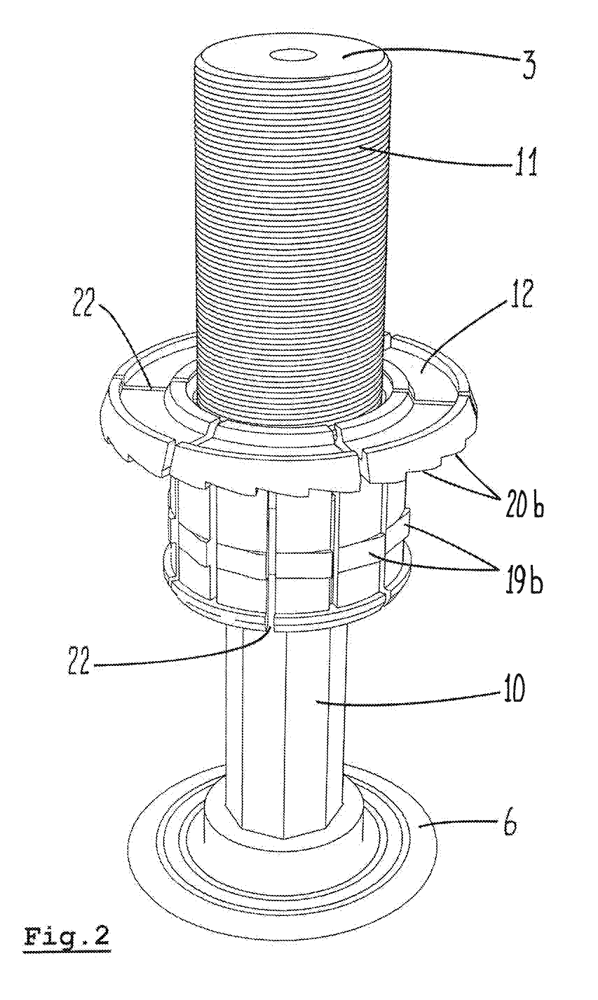

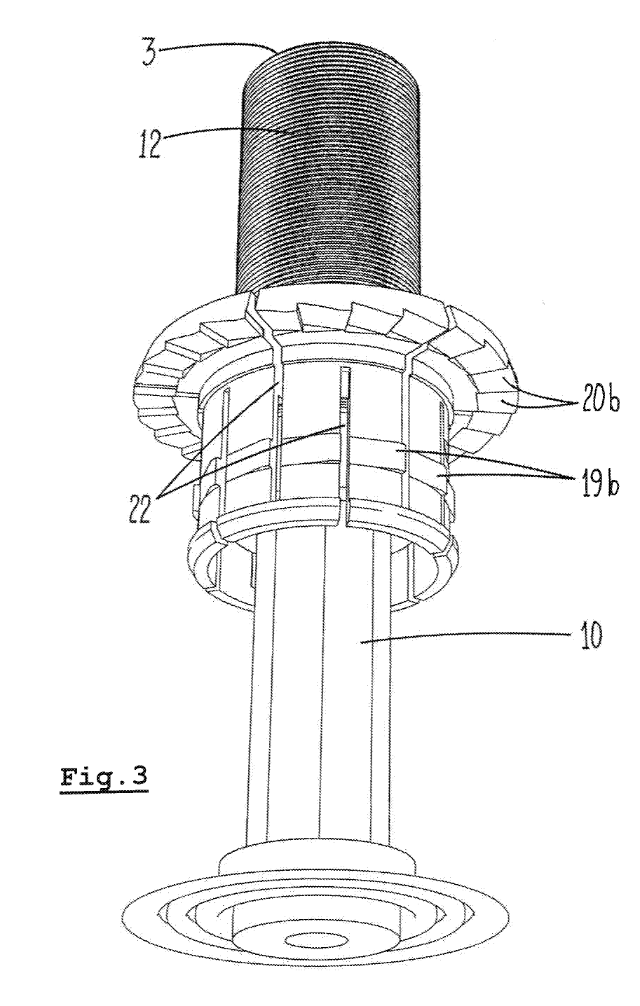

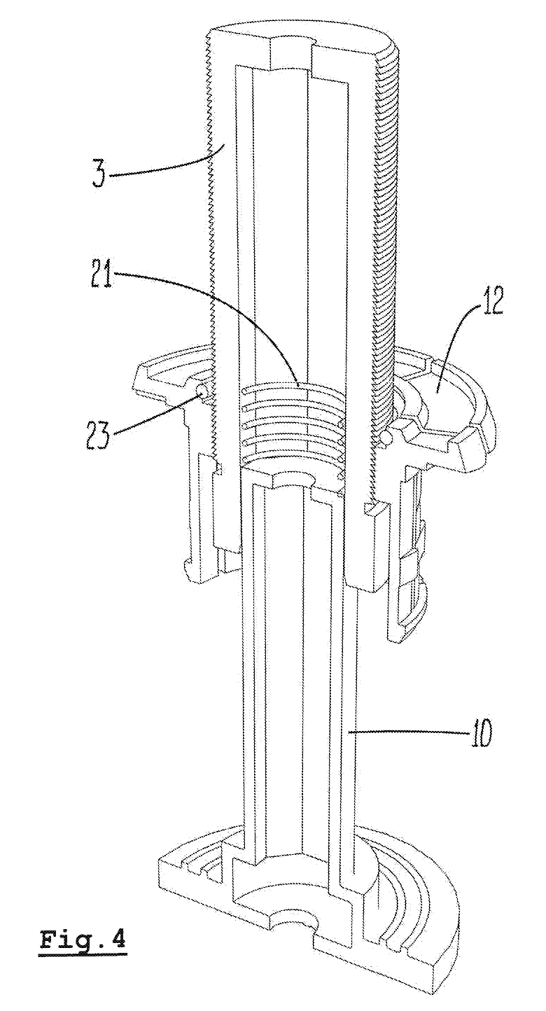

Specifically referring to FIGS. 2 and 3 the drive nut 12 is illustrated in more detail. This drive nut 12 is constructed such that it is deformable between an expanded state in which its inner thread 13 does not engage the outer thread 11 of the plunger 3 and a compressed state in which said threads 13 and 11 are in engagement. In the illustrated embodiment the drive nut 12 is provided with slots 22 allowing the deformation of the drive nut between its expanded and compressed states. A spring ring 23 (best seen in FIGS. 1, 4 and 7) biases the drive nut 12 towards the expanded state. The storage chamber 1, when attached to the collar 7 of the guide housing, engages the outer contour of the drive nut 12 for keeping it in the compressed state in which the threads 11 and 13 are in engagement. The storage chamber 1 and drive nut 12 may be provided with cooperating sloping parts for facilitating the engagement therebetween.

As may appear from a closer look to FIG. 1, the sides of the cooperating inner and outer threads 11 and 13, respectively, engaging each other when the drive nut 12 moves the plunger 3 upwardly for dispensing the liquid substance extend substantially perpendicularly to the direction of movement of the plunger 3. As a result no radial, outwardly oriented forces are generated on the drive nut 12 which would tend to move it to the expanded state.

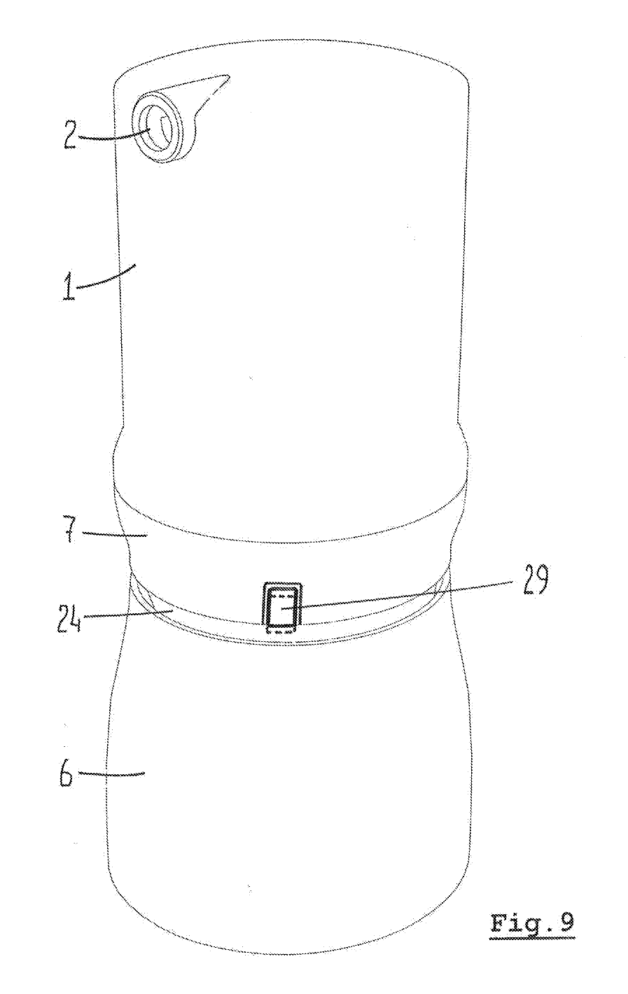

The longitudinal movement (or operational stroke) of the storage chamber 1 relative to the stationary lower part 6 of the guide housing may be determined by a gap 24 between the lower end of the movable collar 7 and a shoulder 25 of said stationary lower part 6 or, alternatively, by a gap 26 between the upper end of the stationary lower part 6 and a shoulder 27 of the converter nut 14. Means may be provided for setting the allowed longitudinal movement (stroke) of the storage chamber 1 (and thus the amount of substance to be dispensed by a single stroke). For example, such means can include limiting the operational stroke by opposed surfaces that come into contact with each other to limit the operational stroke, wherein the position of at least one of the surfaces is adjustable. For instance, FIG. 9 illustrates slider(s) 29 which can slide to different positions (e.g. as indicated in full lines and in broken lines) for setting the gap 24 and thus the operational stroke.

Next the operation of the apparatus will be described, starting from the situation in which a storage chamber 1 has not yet been attached to the guide housing. In this situation the drive nut 12 is in its expanded state and the plunger 3 is in its lowermost position in which the upper wall 28 of the plunger 3 (see FIG. 1) rests upon the compression spring 21 which rests on top of the central column 10. When the storage chamber 1 is attached to the collar 7 (for example by means of a bayonet coupling) the drive nut 12 is compressed and its inner thread 13 will engage the outer thread 11 of the plunger 3. If needed, the plunger may settle downwardly a little (for allowing a correct engagement between threads 11 and 13) as allowed by a slight compression of compression spring 21. The apparatus now is ready for use.

For operation of the apparatus the storage chamber 1 is repeatedly pushed down (manually) while compressing the compression spring 16. This compression spring 16 will move the storage chamber 1 upwardly again after releasing the manual pressure on the storage chamber. During the downward motion of the storage chamber 1 the collar 7 and converter nut 14 also move downward which, by means of guide pin 17 and guide way 18, will lead to a to and fro rotation of the converter nut 14 as explained above. This causes a stepwise rotation of the drive nut 12 in an appropriate single direction (also as discussed before), as a result of which the plunger 3 is lifted on the central column 10 and will engage the piston 4.

Before dispensing substance first all play in the apparatus has to be eliminated by a few idle strokes.

When all play has been eliminated a stroke of the storage chamber 1 will result in a movement of the piston 4 for dispensing an amount of substance through the substance outlet 2.

When the storage chamber 1 is fully emptied (or when one wishes to dispense a different substance) it is removed from the collar 7 in an appropriate manner (for example a slight rotation when a bayonet coupling is provided). As a result the drive nut 12 is disengaged and, under influence of the spring ring 23, will expand, releasing the plunger 3 which will fall down to its original, lower starting position. The impact of the plunger 3 on the central column 10 is dampened by the compression spring 21.

It is noted that, although in this embodiment the plunger 3 returns to its starting position by gravity, also additional means (such as a tension spring) may be provided therefore.

Although the subject matter has been described in language directed to specific environments, structural features and/or methodological acts, it is to be understood that the subject matter defined in the appended claims is not limited to the environments, specific features or acts described above as has been held by the courts. Rather, the environments, specific features and acts described above are disclosed as example forms of implementing the claims.

What is claimed is:

1. An apparatus for dispensing a liquid substance, comprising a storage chamber arranged for storing the substance in communication with a substance outlet, an expulsion member arranged for forcing the substance from the storage chamber towards the substance outlet, wherein the expulsion member comprises a plunger provided with a first thread, and a drive mechanism arranged for driving the expulsion member, wherein the drive mechanism comprises a drive nut with corresponding second thread for engaging the first thread, and wherein the drive nut is rotatable with respect to the plunger.

2. The apparatus according to claim 1, wherein the drive nut is rotatable with respect to the plunger through a longitudinal movement of the storage chamber in parallel to the plunger.

3. The apparatus according to claim 2, and further comprising a guide housing arranged for longitudinally guiding the plunger while preventing a rotation thereof, wherein the storage chamber is movable longitudinally with respect to the guide housing and wherein the drive mechanism further comprises a converter nut arranged for movement longitudinally to and fro in correspondence with the storage chamber while rotating to and fro relative to the guide housing, said converter nut engaging the drive nut for driving it into rotation only when rotating in a first direction.

4. The apparatus according to claim 3, wherein the guide housing and the converter nut together define a guide way and guide pin assembly for causing the to and fro rotation of the converter nut with respect to the guide housing when it moves to and fro longitudinally with respect to said guide housing.

5. The apparatus according to claim 4, wherein the guide housing comprises at least one stationary guide pin cooperating with an inclined guide way of the converter nut.

6. The apparatus according to claim 3, wherein the converter nut engages the drive nut by means of a first ratchet and pawl mechanism.

7. The apparatus according to claim 3, wherein the drive nut cooperates with a second ratchet and pawl mechanism which prevents a rotation of the drive nut opposite to the rotation caused by the converter nut.

8. The apparatus according to claim 6, wherein the number of ratchets differs from the number of pawls.

9. The apparatus according to claim 3, wherein the storage chamber is detachable from the guide housing.

10. The apparatus according to claim 9, wherein the drive nut is deformable between an expanded state in which its second thread does not engage the first thread of the plunger and a compressed state in which said threads are in engagement and wherein the storage chamber, when attached to the guide housing, engages the drive nut for keeping it in the compressed state.

11. The apparatus according to claim 10, wherein the sides of the cooperating first and second threads engaging each other when the drive nut moves the plunger for dispensing the liquid substance extend substantially perpendicularly to the direction of movement of the plunger.

12. The apparatus according to claim 3, wherein the guide housing comprises a stationary lower part and a movable upper collar which moves to and fro longitudinally with respect to the stationary lower part, wherein the storage chamber engages said collar and is arranged for moving in unison therewith and wherein the collar engages the converter nut for causing the longitudinal movement thereof.

13. The apparatus according to claim 2, wherein a compression spring is arranged for loading the storage chamber relative to the guide housing.

14. The apparatus according to claim 1, wherein a compression spring is positioned between the plunger and the guide housing.

15. The apparatus according to claim 2, wherein means are provided for setting the allowed longitudinal movement of the storage chamber.
